(19) United States
(12) Patent Application Publication
(10) Pub. No.: US 2010/0024015 A1
(43) Pub. Date: Jan. 28, 2010

(54) SYSTEM AND METHOD FOR SIMPLIFIED LOGIN USING AN IDENTITY MANAGER

(75) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: SXIP IDENTITY CORP., Vancouver, BC (CA)

(21) Appl. No.: 12/520,101

(22) PCT Filed: Dec. 21, 2007
(86) PCT No.: PCT/CA07/02274

§ 371 Date: Aug. 24, 2009

Related U.S. Application Data
(60) Provisional application No. 60/871,248, filed on Dec. 21, 2006.

(51) Int. Cl. H04L 9/32

(52) U.S. Cl. 726/6

(57) ABSTRACT

A system and method for simplifying a login process makes use of a set of bookmarks that can be used to playback a series of actions and provide a stored username and password to a website or webservice. A user can access a bookmark manager component of the system and an identify manager component of the system either locally or remotely and have the two components act independently of each other but in communication to store the bookmarking and identity information.

### CROSS REFERENCE TO RELATED APPLICATIONS

This application claims the benefit of U.S. Provisional Application No. 60/871,248 filed Dec. 21, 2006, which is incorporated herein by reference.

### FIELD OF THE INVENTION

The present invention relates generally to identity and password management. More particularly, the present invention relates to simplified logins performed in conjunction with an identity manager.

### BACKGROUND OF THE INVENTION

Users of networked services, such as those provided by different websites on the Internet, are required to create accounts with each service provider that they use. There has been a push towards a single-sign on facility from a number of different quarters. Some systems have attempted to use a centralized hierarchical identity model, while others moved towards a system of federated identity. Proponents of a distributed system have forwarded the model of OpenID that allows a user to create a login that can be used at any of a number of sites. However, due to the vast number of existing systems, and the fact that no one service has become sufficiently established, users are still tasked with tracking their own logins.

Password management systems have been employed to allow users to manage the large number of logins that they have. These systems can be integrated within the web browser, they can be a function of the operating system of the platform used by the user, or they can be standalone applications or web browser plugins. These address a number of issues for users, but other issues still remain.

Often websites provide users the ability to remain logged in after an initial login using persistent sessions facilitated by the use of cookies. This provides users with a convenient login, but the user often does not know if he is logged into a service or not. Though this is not a substantive issue with systems that only have one user, if a user wants to log out of a service, it often requires the user to navigate back to the site to determine if the login from the previous session is still active.

Users are required to track the different login pages for the services that they use. Often the login pages are accessed through a link on the initial page displayed when a user visits a website. Often users make use of bookmarks to allow direct access to the login pages, and then they can make use of a login manager to log in to the service. Bookmark lists allow the user to conveniently access these sites without having to either remember the URL of the site, and without having to type the URL into the address bar of a web browser. A number of services have arisen to provide a user with access to his or her bookmark list from a number of computers. These services, such as Del.icio.us and Google's BrowserSync, allow a user to access a centralized store of bookmarks on any computer that they use.

As mobile platforms become more prevalent, it is becoming increasingly common that a centralized bookmark list presents problems. A user who has bookmarked the login page from a desktop computer often finds that when she uses the same link from a mobile platform the login is not possible as it must be done through a specific mobile login page despite the face that the same login credentials are used.

Many password management systems provide users with generated passwords to sites. These passwords are typically unique for a user-site pairing. This ensures that the user is not making use of the same password at different sites, a common security problem. This causes problems for many users when they attempt to access websites and services from another computer, as they do not have access to the generated password if the password manager is not cross platform compatible.

Bookmarking a login page that is not the first page provided at a website presents other problems as well. If the service provider changes the page used for logins, the users is stymied and must remove the old bookmarks and replace them with new bookmarks, and often a new login mapping must be provided if a password manager is used. Though this makes logical sense from the perspective of the intent of the applications, from the perspective of the user who simply wants to login, this is an inconvenience.

FIG. 1 illustrates a flowchart of a conventional mechanism for logging in to a website. In step 50, the user navigates to the login page. This can be done in any of a number of ways, including directly entering the universal resource locator (URL) associated with the website login page into an address bar in a web browser. Alternatively, the user can view bookmarked pages in step 52 and select the bookmarked login page in step 54. The bookmarks can either be local to the user, or can be access from a networked service.

When the browser is provided instruction to retrieve the page at the defined URL, it first checks to see if the page exists in step 56. If the page does not exist, an error message is displayed in step 58. The error message can be generated by either the browser or the site that is being accessed. If the page exists, the webservice often checks to determine if there is a persistent login that is provided by a cookie. This check is done in step 60. If there is a persistent login, the user is logged in to the system and provided access to the webservice in step 64. If no indication of a persistent login is found, the user is required to provide login credentials in step 62. This can be done either under user control, or through a password manager or identity management system. Upon successful submission of credentials, the user is logged in to the webservice in step 64.

There is a disconnect between directing users to a website, and providing users access to the website. These two tasks have been viewed by developers as disjoint activities, though to a user they are one in the same. A user does not necessarily want to be delivered to the front door of a service; instead the user wants to make use of the service. However, a mechanism to allow users to directly access services has not been provided.

### SUMMARY OF THE INVENTION

It is an object of the present invention to obviate or mitigate at least one disadvantage of the prior art.

In a first aspect of the present invention, there is provided a method of managing a user login process to a networked service provider. The method comprises receiving a request from a user to access a service; selecting a login process from a set of stored login processes in accordance with the service associated with the received request; and logging in to the service using a method determined in accordance with the selected login process.

In an embodiment of the first aspect of the present invention, the step of selecting a login process includes selecting a login process appropriate to a platform associated with a web browser through which the service is accessed. In another embodiment of the first aspect, the step of logging in includes playing back a login script associated with the service, where the login script includes a plurality of hypertext transfer protocol requests, one of which includes a username and password. In another embodiment, the step of logging in includes issuing a hypertext transfer protocol request containing a username and password. The user name and password can be selected from a user identity store in accordance with the service.

In a second aspect of the present invention, there is provided a method of restoring the local state of a web browser to a previous condition. The method comprises initiating a monitoring of a session of the web browser; recording the local state of the web browser at the initiation of the monitoring; receiving a user request to end the monitored session; and restoring the local state of the web browser to the recorded local state.

In an embodiment of the second aspect, the method further includes the step of clearing the local state upon receiving a user request to end the monitored session. The local state can include at least one of: a set of stored cookies associated with the web browser, a cache employed by the web browser and a web browser history.

In a third aspect of the present invention there is provided a login automation system comprising a bookmark store, a user identity store and a login manager. The bookmark store stores the location of a login page. The user identity store stores user login information associated with the login page. The login manager retrieves the location of a login page from the bookmark store and login information associated with the retrieved login page from the user identity store, and initiates a login to a service provider using the retrieved login page and login information upon receipt of a login request from a user.

In an embodiment of the third aspect of the present invention, the login automation system further includes a login status store for storing the login status of a user account at at least one service provider. The login manager can include a login status monitor for accessing and updating the login status store to reflect the login status of the user at the at least one service provider. In another embodiment, the login page location is stored within a login mapping stored in the bookmark store. The login mapping can include a login script for use by the login manager to initiate the login to the service provider, or it can include a login URL for use by the login manager to initiate the login to the service provider.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a flowchart of a conventional method of logging in to a service;

FIG. 2 illustrates an exemplary embodiment of a user interface for a login automation system of the present invention;

FIG. 3 illustrates an exemplary embodiment of a user interface for a login automation system of the present invention;

FIG. 4 illustrates an exemplary embodiment of a user interface for a login automation system of the present invention;

FIG. 5 is a flowchart illustrating a method of automating a login according to a method of the present invention;

FIG. 6 is a flowchart illustrating a method of handling a global login request according to a method of the present invention;

FIG. 7 is a flowchart illustrating a method of automating a logout from a service provider according to a method of the present invention;

FIG. 8 is a flowchart illustrating a method of of restoring the local state of a web browser to a previous condition according to a method of the present invention; and

FIG. 9 is a block diagram illustrating a system of the present invention

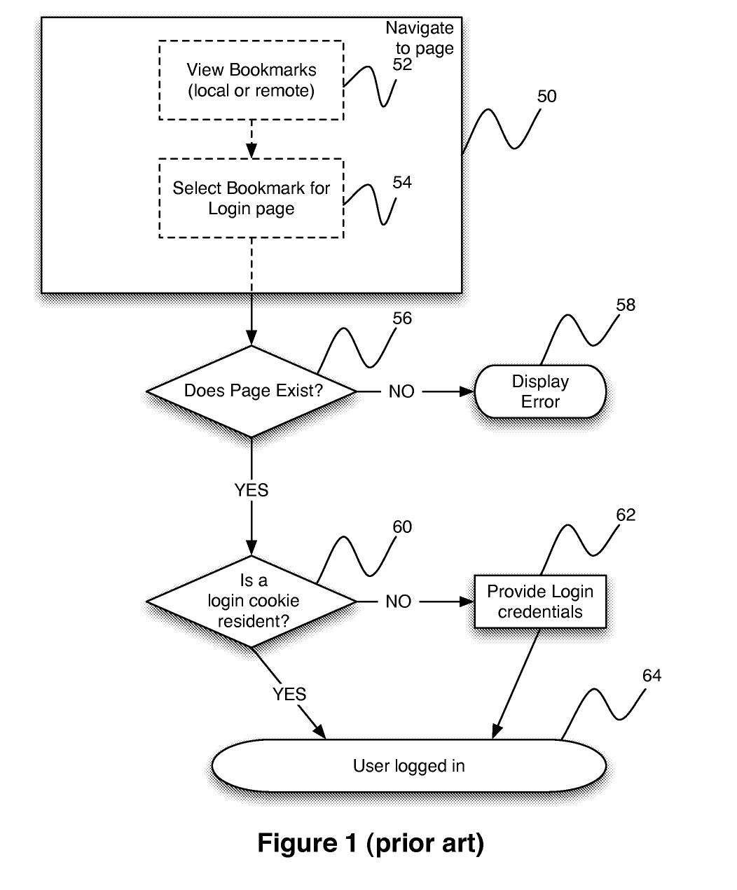

### DETAILED DESCRIPTION

Generally, the present invention provides a method and system for simplifying the login procedure to websites.

As noted above, one of the fundamental problems provided by existing technologies is that there is a disjoint implementation of login management and bookmarking. The system of the present invention provides the user the ability to log into a service as opposed to the prior art system of navigating to a page and then logging in. Though shown in the accompanying figures and discussed in the following description as making use of distinct databases for login page bookmarking and identity information, those skilled in the art will appreciate that a single database, or another structure, can be used. It is also important to note that the databases need not be co-located, nor do they need to be either local or remote from the user. One of the databases can be local while the other is remote, they can be integrated with each other or not. So long as the login manager has data access to the information in the database, it is sufficient. It should be further noted that the login manager can be either local to the user or remote. It can be offered as a webservice, a plugin to a browser, or even on a dedicated hardware element such as a USB memory key.

Prior art attempts at connecting bookmark systems and login systems have been stymied by many websites maintaining logins across sessions and by websites using login pages that contain session information that cannot be stored in a bookmark. Login pages that contain session information are typically accessed from another page where a user would click on a login icon.

In the system of the present invention, a login manager makes use of both a bookmark store and an identity store to navigate a site to facilitate logins. Where a site makes use of a standard http form for submitting login information, the login manager can generate the http request containing the login information and issue to the command to facilitate a one step login. In the event that a site makes use of session tracking information which makes knowing the address of a login page impossible, the login manager can access a script that is used to navigate through the pages required to access a login page, and then issue the http request that contains the user credentials to allow the login. The login manager can also track the state of persistent logins facilitated by cookies stored by the user's browser, and thus track which sites the user is already logged in to.

Reference is made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements. Those skilled in the art will appreciate that a number of different constructs can be used to implement the functionality outlined below, and that no one embodiment should be considered as limiting the scope of the present invention.

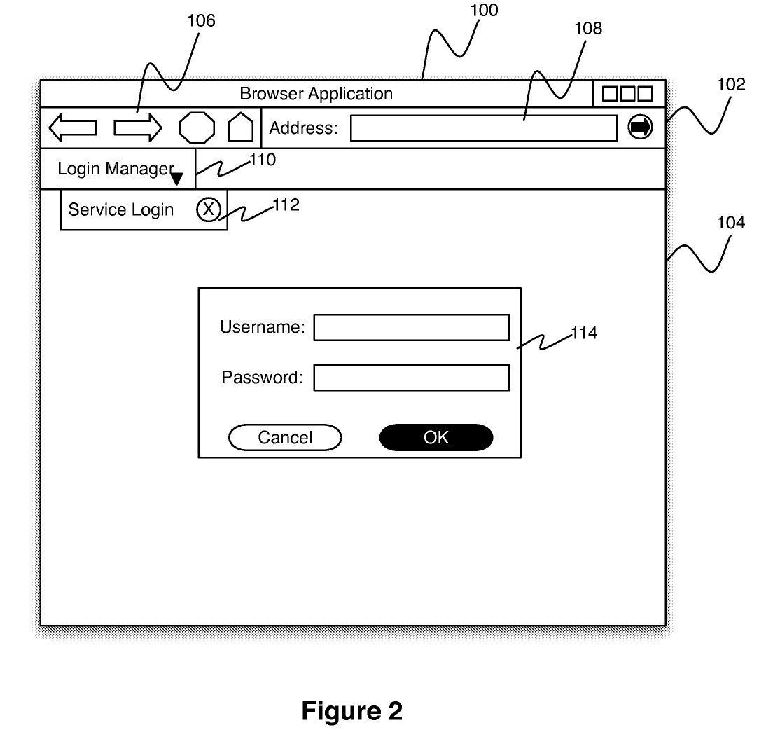

FIG. 2 illustrates the login screen provided to the user of an embodiment of the present invention. The present invention can be implemented as a web-browser plugin, a web browser extension, it can be integrated within the browser, and it can be implemented as a web-based application. In FIG. 2, a web browser 100 is illustrated. The browser is composed of two parts, a browser chrome 102 and a browser window 104. The chrome 102 contains the menu, navigation icons 106, the address bar 108 and any toolbars or other non web viewing elements. The display 104 is used to display the rendering of the web pages. In the illustrated embodiment of FIG. 2, the login manager of the present invention is provided as an element of the web browser, offered either as an integrated element or as a browser plugin. The login manager is presented as a toolbar element 110, that permits a user to access a drop down menu. The user may be required to login to the service to ensure that before a user is logged into a number of webservices, he has been authenticated. The service login selection 112 is then activated by the user, and a login dialog box 114 is presented. Though illustrated as requiring a username and password, in other embodiments other credentials can be used, including possession of a device such as USB device, biometric recognition such as a fingerprint scan, a voice authorization, and the provision of a PIN on a mobile device. In other embodiments, authentication can be performed by the operating system so that the application can obtain confirmation from the operating system that the user has been authenticated. Where a device is used to store a component of the application, or where a device is used as part of the authentication process, the user may only be prompted for a password or a PIN, as possession of the device and the shared secret can be considered as sufficient information for authentication purposes.

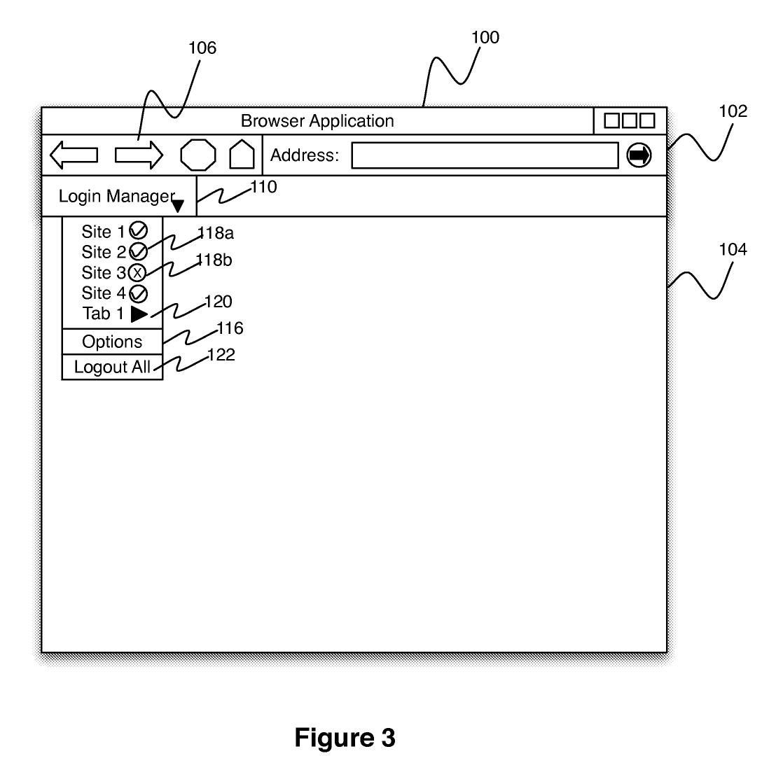

As illustrated in FIG. 3, the user is provided a list of sites for which login information is stored after being authenticated. The same browser 100 with chrome 102 and window 104, navigation icons 106 and address bar 108 is illustrated. Login manager 110 has now authenticated the user, and presents a list of sites 116 for which login information is known. If the login manager is able to track persistent logins, login indicators 118a and 118b can be used to indicate whether a user is logged into a site or not. In addition to the links, a group of links can be collected together under a tab 120 to provide for better organization. The ability to log out of all sites that the user has logged into can also be provided through a Logout All function 122.

Because various web-based services and websites make use of cookies to allow persistent logins, the present invention can track the cookies that are locally stored by recognized services and sites. This information can be used to indicate to the user which services and sites are presently logged in.

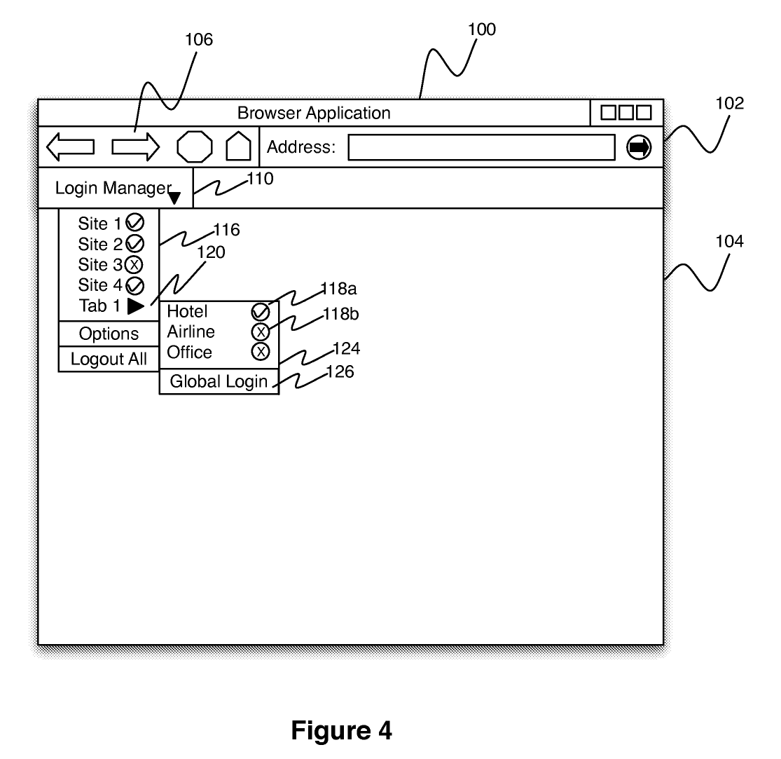

FIG. 4 illustrates browser 100, with chrome 102, window 104, navigation icons 106 and login manager 110. From menu 116, the user has selected Tab 1 120. A dependent menu 124 is presented that lists a grouping of sites with login indications 118a and 118b for each. A global login function 126 is also provided to allow the user to log in to all the sites in the drop down menu 124.

Logging a user out of a site can be accomplished in one of many ways, and will be illustrated in greater detail further below. The logout functionality for a given site can include either deleting the cookie that is used to track logins, or it can be accomplished by playing a logout script, similar to the login script used to access a site, that simulates the user going to a page on the site and clicking on a logout link.

The user can also be provided the ability to specify that upon logout, all cached paged and links to pages in the browser history will be cleared. This prevents other users from viewing what the user was doing when access is obtained from a public terminal.

The login manager can provide the user with the ability to remove traces of all activity that was undertaken, whether it relates to services that require login or not. This can be accomplished by removing all cookies, cached pages and links in the history that were created during a session. The present invention can accomplish this in a number of different ways. In a first embodiment, the manager tracks all cache entries, all history events and all cookies received during a session, and upon instructions to logout from all services. In another embodiment, the bookmark manager can capture the state of the browser cache, history and cookies upon initialization, and can then restore the browser to the previous state. This allows the user to effectively remove many of the traces that would otherwise have been left behind. It also allows a user to make use of another person's computer, login to a number of services that the owner of the computer may typically use, and upon logout leave the computer in a state that allows the computer owner to take advantage of a persistent login where appropriate.

When a computer is used by different users, or if a single user would like to have different personas, different username and password combinations can be used to access different sets of identity data. If a user wishes to maintain a single username password combination but have different sets of login information for a given website or service, the present invention can provide the user the ability to select the persona to be used at a site. This can be done in any of a number of ways including, but not limited to, a pop up dialog box providing a list of the stored persona for a given site, and a nested menu option that provides a list of the stored persona. The mechanism used to display this information can be configurable by the user. Thus, a user can access different personas in a plurality of different ways depending on the implementation of the present invention. In one implementation, each different persona requires a different set of login credentials, in a second embodiment, each user requires a login, and after login, the user is able to select a persona. The selection of the persona can be done through selection of a persona from a pick list, or through other means understood by those skilled in the art. All logins initiated will be done with accounts associated with that persona until a different persona is selected. In a third embodiment, after the user authenticates with the login manager, no persona selection is performed. If a user has multiple accounts with a site, prior to initiating a login to that site, the user is prompted to select the persona that should be used for logging in to the particular site. Thus, personas can be treated as being so distinct that they each require a different login, they can be selected by a user after authentication and used for all logins until the user selects a different persona, or they can be site specific and require user indication at the time of selecting a site as to which persona is to be used.

The information used to allow a login to be automated is referred to as a login mapping. Mappings include both recorded scripts of http requests and http requests that can be immediately issued to invoke a login using stored login information. Mappings can be generated by any of a number of mechanisms including centralized mapping generation and distributing the mapping generation to the user base of the login manager. The creation of a login script mapping can be generated by tracking user behavior as the user logs into a service and forwarding the information to a central server for parsing. By distributing the mapping generation to users, a first user to log in to a service provider generates a mapping that is then used by subsequent users. This allows a distribution of work among a number of different users to build a database of login information.

By associating a login mapping with both a service provider and a platform, the login manager can determine the script to use to log in to a service based on the platform that the user is using. This allows a user to select a login based on a provider name without needing to consider the difference between a mobile platform and a full factor platform such as a desktop or laptop computer. When a login script needs to be modified due to a service provider changing the topology of a website, the first user to encounter the problem can generate a new mapping that can be used by other users, thus removing the inconvenience of having the wrong page bookmarked for other users.

Users can also be provided the ability to share bookmarked login information, including specific logins. This can be done on a selected or global basis. On the selected basis, a first user can delegate permission to a second user to access a service on behalf of the first user. This can be used for a number of different purposes including allowing an executive to delegate access to travel and hotel reservation services to an assistant who can then make reservations on behalf of the executive.

The delegated login permits the executive to provide access to a site without providing password information to the assistant. The access to the site can be audited so that the owner of the login can be provided a list of who logged into the account (based on which login manager used the login), when the login occurred, and what was done.

On a global basis, a user can create a login to a site and simply share the information with a community. For services that required information that many users do not want to provide, this allows a first user to create a login and simply share the login with others. Presently this is done by publicly posting login information on a website and allowing users to copy and paste the information into a login page. This automated approach reduces typographic errors and provides a degree of certainty that the login will work.

One skilled in the art will appreciate that when the user authenticates with the login manager, though illustrated in FIG. 2 as requiring a username and password combination, a number of different types of authentication can be considered as acceptable. On mobile platforms, it is not always convenient for the user to provide a username and password combination due to the reduced form factor, and possible limited scope of the input device. Possession of the device can be considered as a first part of a shared secret exchanged used to authenticate the user. During the initialization of the login manager, the serial number of the mobile device can be used to determine if the device is valid. If the device has been lost, the user can report it stolen to the carrier and have the device deactivated. This will prevent other from accessing the login manager. Thus, possession can be interpreted as a part of the identity equation. To further ensure that the user is legitimate an alternate verification can be performed. This alternate verification can be the provision of a PIN in place of a password, or a voice authentication. This permits the user to secure the passwords and login information, but still provides ease of access to the intended user. On any platform, authentication mechanism including biometric tests, voice scans, and possession of a physical token, possibly in conjunction with a password, a PIN, or another shared secret can be used for authentication.

Although the user can be required to authenticate at the beginning of a session, access to various sites, such as banking sites, can be subject to further authentication challenges based on either a service provider or user determined policy. Such a policy be set to confirm that the person accessing the site is in fact the person authorized to access the information. The login manager can recognize these sites, either through an agreement with these sites, through recognition of metadata stored in the access page, or through other conventional means such as a maintained list of sites, and then prompt the user to re-authenticate when the service or site is selected. Thus, sites requiring instant authentication can be provided a reassurance that the user has been authenticated prior to logging in. In another embodiment, instead of requiring that the user re-authenticate, the user can be prompted to provide an additional password, or can be asked for some other shared secret such as a mother's maiden name, of a place of birth. This information can be used to reauthenticate the user, and thus provide multi-factor authentication. The second shared secret can be provided to the site, or it can simply be confirmed by the login manager.

One skilled in the art will appreciate that there are a number of single sign on facilities being offered by a number of nascent identity management protocols. These protocols include OpenID, Shiboleth and various embodiments of SAML. The system of the present invention can interact with sites making use of these protocols, by presenting the user with login links that appear to be identical or similar to other login links, but that make use of these protocols to perform the login by accessing information in the identity manager. Login links that make use of identity management protocols can make use of a different status icon to indicate that the login is based on an identity management protocol.

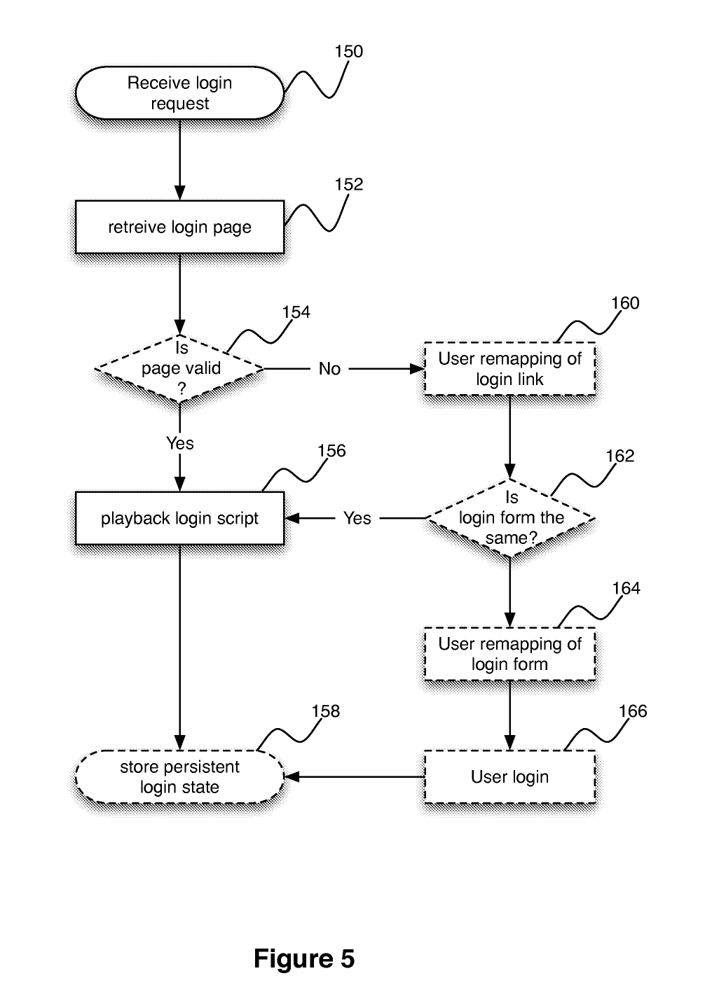

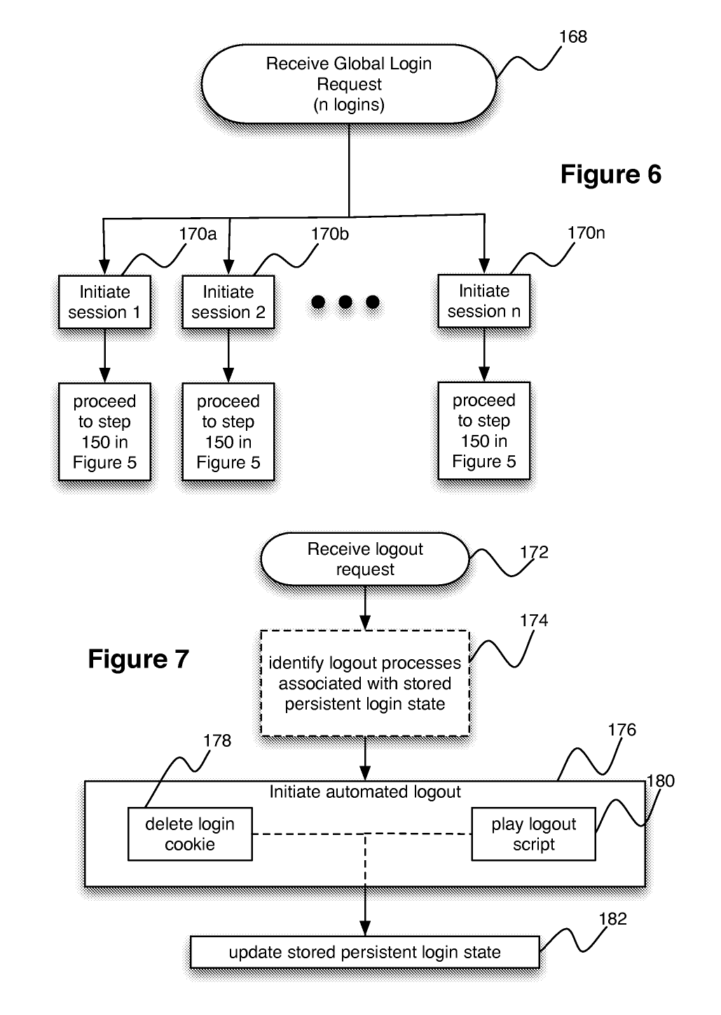

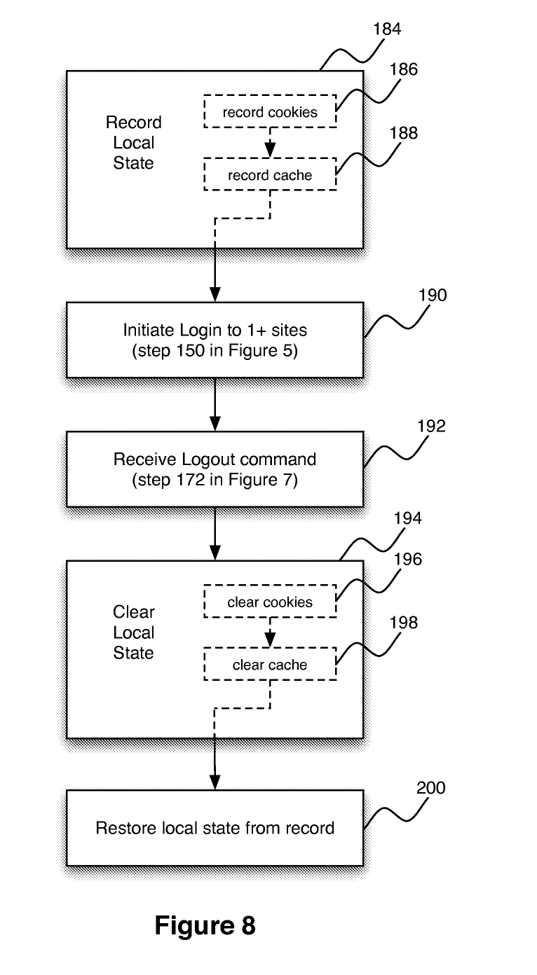

FIG. 5 illustrates a flowchart for a method of providing automated login to a service provider. In step 150, the login manager receives a login request from the user that specifies the service provider for which the login is required. The specification can be either by specifying a service provider identifier that is then used, with other information, to determine the login page, or it can be a request for a particular page that is associated with a login script. The login page is retrieved in step 152. If the service provider that the user has specified has changed the login page location, an error will be detected in step 154. If the login page is valid, the login script is played back in step 156 to log the user in to the service provider. In step 158, the login manager optionally updates a list of persistent logins that are maintained by cookies. If in step 154 an error is detected and the page does not exist, the user is asked to remap the login link in step 160. If, in step 162, it is determined that the login form is the same as it was previously, the login script is played back as the method returns to step 156 as above. If the login form is not the same, the user is asked to remap the login form in step 164, and upon the user logging in step 166, the persistent login status list is updated, as described above, in step 158. Hashed lines are used on steps that are optional to the method. Optional steps provide functionality that may not be core to the present invention. Thus, determining the validity of the login page, and the process of asking a user to regenerate the login script is optional, as is storing the persistent login state information. The storing of persistent login state information is used for both providing information on which services the user is logged in at, and to provide a logout functionality.

FIG. 6 illustrates a method of a global login. In FIG. 4, a global login option 126 is shown. When the user selects this option, the login manager issues login requests to each of the services in the tab. Although not indicated on the menu 116, it is not outside the scope of the present invention for the global login feature to be provided on the primary menu 116. Upon receiving the global login request in step 168 the login manager will create a number of sessions of the browser. This can be accomplished in any of a number of ways. New instances of the browser application can be initiated, new browser windows can be initiated, or if the browser supports browsing in tabs (or the relevant equivalent) new tabs can be created in step 170. As shown in FIG. 6, step 170a-170n is performed to create a sufficient number of browser sessions to support the number of logins required by the global login request. Following the creation of a session in any one of steps 170a-170n, each of the sessions proceeds to step 150 in FIG. 5 with instructions to log each session in to one of the services in the global login request.

FIG. 7 illustrates a method logging out a user from a service. Typically providing a logout functionality indicates that the login manager is tracking the login state of the user at a number of different sites. However, if a logout script is used, a user can be provided the ability to logout from a site that is not indicated as logged in. A method of globally logging out can be provided, similar to the method illustrated in FIG. 6, but instead of proceeding to step 150 of FIG. 5, the method would proceed to step 172 of FIG. 7.

In step 172, the login manager receives a request to log out from a service provider. The process used to log a user out of the service provider associated with the request is optionally determined in step 174. In step 176, the automated logout is initiated. In some embodiments, only one logout mechanism is provided, and thus step 174 would not be needed, but in embodiments where a plurality of logout mechanisms are supported, the determination of the logout method is preferred. The determination can be made in conjunction with stored user preferences, a service provider preference, or the user can be prompted at the time of the logout request to select a method. Two examples of logout mechanisms are the deletion of a cookie used to track persistent sessions (step 178) and playing back a recorded logout script (step 180). After the automated logout of step 176, the persistent login state data is updated in step 182 to reflect that the user is not logged in.

The deletion of a session tracking cookie is non-ideal for certain sites, including banking sites that prefer that the user make use of a logout link that clears confidential information from caches that may exist on either the user's local system or on the service provider's system.

The present invention provides a mechanism for a user to use another person's computer and upon logging out from the session, remove indications that the computer was used. One such implementation is shown in FIG. 8. In step 184 the local state of the browser is recorded. This can include creating a list of cookies (step 186) and a record of cached data (step 188) that may include the browser history. The user then initiates a login to 1 or more sites in step 190. The login can be performed using the method of FIG. 5, or it can be performed by the user manually logging in to a site using the site's preferred authentication mechanism. In step 192, after completing whatever activities were desired, the user issues the logout command. A logout process such as that illustrated in FIG. 7 can then be performed. The login manager, in step 194, clears the local state of the browser. This can include both clearing the browser cache (step 198) and the cookies (step 196) of the browser. Clearing the local state allows the user to prevent another user from determining which activities the user had performed based on a browser history, the presence of cookies or the cache.

In step 200, the recorded local state from step 184 is restored. This restores the browser to the state it had prior to the user beginning the session. As an example of the utility of this function, a user can login to a remote login manager from another person's computer. The browser that the user is using has a number of persistent login cookies, and the user may need to access the same sites that the cookies are there for. This will result in the user logging the other user out. By storing the local state of the browser at the start of the session, and then restoring the local state at the end of the session, the users is provided with a simple mechanism to prevent the other person from knowing which sites have been visited, and allows the user to prevent inconvenience to the other person as well.

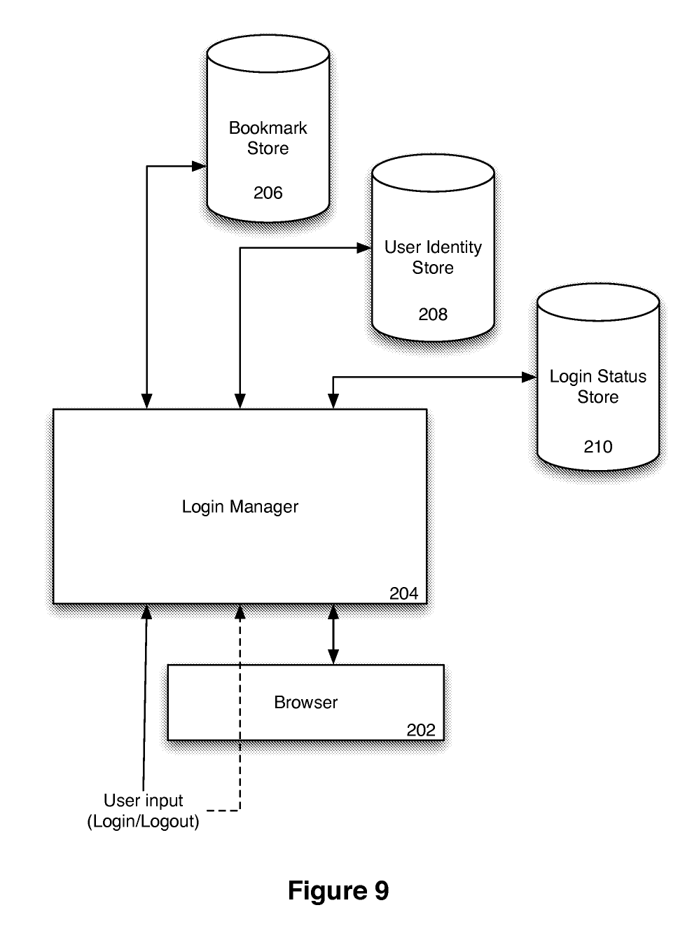

FIG. 9 illustrates a system of the present invention. One skilled in the art will appreciate that the various information stores discussed below need not be distinct from each other, and any data structure that can provide the functionality needed can be used. A user interacts with a login manager 204, either directly or through a web browser 202. The login manager accesses a bookmark store 206, a user identity store 208 and a login status store 210. The login status store 210 is not essential for the operation of the system of the present invention, though for embodiments that track whether the user is logged in to particular services, it is used. The communication between the login manager 204 and any of the other elements in the system is bi-directional.

When a user authenticates to the login manager 204, the login manager 204 can access both the bookmark store 206 and the user identity store 208 to determine which sites login information is available for. From this list of sites the menus shown in FIGS. 2-4 can be created. When a user issues a request to be logged in to a particular site, the login manager 210 determines the method of logging the user in to the service in accordance with data stored at at least one of the bookmark store 206 and the identity store 208. The login script, or the http request containing the login is then transmitted through the browser to the service provider. When a cookie is received, it can be recorded in the login status store 210 by the login manager 204. It should be noted that the data connectivity between the data stores 206, 208 and 210 and the login manager 204 need not be direct, and may be created through browser 202. The user identity store 208 can be integrated with an identity management system, and can be either local or remote to the system that the browser is on. If any of the data stores 206, 108, 210 are local, the user can be provided the ability to synchronize the stores with the data stores on another system so that when login information is provided on one system, it can be used on another system.

When login and logout requests are received by the login manager, the determination of the mapping used, including the URL that the browser is directed to can be made in conjunction with the information in the bookmark store 206 as well as with other factors. If a browser 202 indicates that it is a mobile platform browser, and a service provider offers a mobile platform specific login, the login manager 204 can select a URL pointing to the mobile platform specific login. Similarly, if the login manager can determine the geographic location of the user, and the service provider that the user has issued the login request for has a geographic region specific login, the correct login site can be used. This logical separation of the login request from the URL used to log in to a service, allows the mappings to be updated by users in the event that the mapping is incorrect. The remapping of a login allows subsequent users to not detect that the login mapping has changed.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of managing a user login process to a networked service provider comprising:
receiving a request from a user to access a service;
selecting a login process from a set of stored login processes in accordance with the service associated with the received request; and
logging in to the service using a method determined in accordance with the selected login process.

2. The method of claim 1 wherein the step of selecting a login process includes selecting a login process appropriate to a platform associated with a web browser through which the service is accessed.

3. The method of claim 1 wherein the step of logging in includes playing back a login script associated with the service.

4. The method of claim 3 wherein the login script includes a plurality of hypertext transfer protocol requests.

5. The method of claim 4 wherein one of the plurality of requests includes a username and password.

6. The method of claim 4 wherein the username and password are selected from a user identity store in accordance with the service.

7. The method of claim 1 wherein the step of logging in includes issuing a hypertext transfer protocol request containing a username and password.

8. The method of claim 7 wherein the username and password are selected from a user identity store in accordance with the service.

9. A method of restoring the local state of a web browser to a previous condition comprising:
initiating a monitoring of a session of the web browser;
recording the local state of the web browser at the initiation of the monitoring;
receiving a user request to end the monitored session; and
restoring the local state of the web browser to the recorded local state.

10. The method of claim 9 further including the step of clearing the local state upon receiving a user request to end the monitored session.

11. The method of claim 9 wherein the local state includes at least one of: a set of stored cookies associated with the web browser; a cache employed by the web browser; and a web browser history.

12. A login automation system comprising:
a bookmark store for storing the location of a login page;
a user identity store for storing user login information associated with the login page; and
a login manager for retrieving the location of a login page from the bookmark store and retrieving login information associated with the retrieved login page from the user identity store and for initiating a login to a service provider using the retrieved login page and login information upon receipt of a login request from a user.

13. The login automation system of claim 12 further including a login status store for storing the login status of a user account at at least one service provider.

14. The login automation system of claim 13 wherein the login manager includes a login status monitor for accessing and updating the login status store to reflect the login status of the user at the at least one service provider.

15. The login automation system of claim 12 wherein the login page location is stored within a login mapping stored in the bookmark store.

16. The login automation system of claim 15 wherein the login mapping includes a login script for use by the login manager to initiate the login to the service provider.

17. The login automation system of claim 15 wherein the login mapping includes a login URL for use by the login manager to initiate the login to the service provider.
